(19) United States
(12) Patent Application Publication
(10) Pub. No.: US 2025/0230387 A1
(43) Pub. Date: Jul. 17, 2025

(54) METHOD AND SYSTEM FOR LIQUID RECOVERY

(71) Applicant: Exothermics, Inc., Amherst, NH (US)

(72) Inventors: Stephen G DiPietro, Mont Vernon, NH (US); John K Philbrick, Milton, NH (US); Matthew C Smith, Milton, NH (US)

(21) Appl. No.: 18/567,838

(22) PCT Filed: Oct. 3, 2023
(86) PCT No.: PCT/US2023/075800

§ 371 Date: Dec. 7, 2023

Related U.S. Application Data
(60) Provisional application No. 63/415,159, filed on Oct. 11, 2022.

(51) Int. Cl. C12H 1/22; C12G 3/07

(52) U.S. Cl. CPC C12H 1/22; C12G 3/07

(57) ABSTRACT

The system and method for extracting a liquid of interest from a vessel. In some applications the liquid of interest is bourbon, and the vessel is an aging barrel made of wood. In some cases, the aging barrel is made of oak and there is a char layer on the interior of the aging barrel. The problem of reduced recovery of usable liquid product from a storage vessel is solved by using vacuum extraction of a preheated vessel, where the vessel is undamaged, and the useable liquid product requires no post-recovery concentration step.

### CROSS REFERENCE TO RELATED APPLICATIONS

This application is a 371 application of PCT/US23/75800 filed Oct. 3, 2023, which claims the benefit of U.S. Provisional Patent Application No. 63/415,159, filed Oct. 11, 2022, the content of each of which is incorporated by reference herein in their entirety.

### FIELD OF THE DISCLOSURE

The present disclosure relates to the recovery of liquid from porous materials and more particularly to the use of a system for recovering liquid from wooden storage vessels.

### BACKGROUND OF THE DISCLOSURE

There are many industries where liquids are aged in a wooden barrel. Some of these include, but are not limited to bourbon, whisky, distilled spirits, wine, soy sauce and olive oil. In some cases, the interior of the wooden barrel is charred or burnt. In some cases, the barrels are oak. In some cases, the material the vessel is constructed from is American White Oak.

There can be varying degrees of charring used in an aging barrel, and the charring is typically done to change the nature of the wood, to yield the best possible reaction between the wood of the barrel and the liquid being aged within the barrel. Some of the components of the wooden (e.g., oak) barrel include, but are not limited to cellulose, which creates a tight bond, hemicellulose, lignin, tannins, and oak lactones. The extent to which a barrel is charred will have an impact on these components.

Hemicellulose is one of the most important components of American oak. When exposed to high levels of heat (284° F. and above), hemicellulose will break down into wood sugars, allowing for some caramelization on the interior surface of the barrel. Lignin is also important since vanillin and spice come from lignin. The more a barrel is charred, the more the lignin yields flavors of spice and smoke. Tannins are typically reduced by allowing the barrel to dry out, but the remaining tannins aid in long-term maturation of certain spirits, for example. In some cases, the higher the char, the mellower the interaction between a spirit and tannin. Lastly, oak lactones are present in many species of oak tree, but in higher volume in American oak. Oak lactones are said to add coconut and woody flavors. The higher the char, the less the impact of the oak lactones.

Levels of char vary depending on the barrel producer, the distillery, or the liquid to be aged within the barrel. Char levels are typically No. 1-No. 4. A No. 1 Char is about 15 seconds, a No. 2 is about 30 seconds, a No. 3 is about 35 seconds, and a No. 4 Char about 55 seconds.

Existing “water soak” methods for bourbon recovery, for example, take eight weeks, use vast quantities of water, and yield “boozy water” that needs to be further reduced to obtain a usable product, whether to be used in diluting other spirits, or as a premium product. Millions of gallons of water are used for this form of reclamation procedure, and this “spent” water needs to be disposed of in an environmentally responsible fashion.

It has been recognized that existing methods of recovering a liquid of interest from barrels are costly, wasteful, and have negative ecological implications. Additionally, the liquids of interest that are “recovered” are often diluted during the recovery process and must be further refined/concentrated adding time and energy costs to the recovery.

Wherefore it is an object of the present disclosure to overcome the above-mentioned shortcomings and drawbacks associated with conventional liquid recovery systems.

### SUMMARY OF THE DISCLOSURE

The system and method of the present disclosure provide for liquid recovery for liquids within a material. One aspect of the disclosure uses a vessel preheating step, a vacuum extraction step, in a modular, mobile system that is efficient, ecologically sound, and less expensive than current methods.

One general aspect includes a method for liquid recovery. The method also includes heating a vessel that may include a material at a temperature for a period of time to produce a preheated vessel. The method also includes removing a plug from a drain hole formed in the preheated vessel. The method also includes placing the preheated vessel into a vacuum chamber. The method also includes rotating the preheated vessel to align the drain hole formed in the preheated vessel with a bottom of the vacuum chamber. The method also includes evacuating the vacuum chamber. The method also includes collecting a liquid recovered from the material of the vessel.

Implementations may include one or more of the following features. The method for liquid recovery where the vessel is preheated to a temperature of about 140° F. The vessel is heated at temperature of 200° F. or less for a period of time of less than 10 minutes. The method for liquid recovery may include moving a collection pan into fluid connection with the drain hole formed in the vessel. Evacuating the vacuum chamber is to a pressure of about 140 torr for about 4 to 10 minutes. The method for liquid recovery may include closing a foreline to isolate the vacuum chamber from a vacuum pump. The method for liquid recovery may include venting the vacuum chamber via a vent valve to atmosphere. The method for liquid recovery may include collecting the liquid of interest in a collection pot that is chilled.

One general aspect includes a system for liquid recovery. The system also includes a vacuum chamber that may include at least one sidewall and at least one door being configured to receive a preheated vessel made of a material, the preheated vessel having an amount of a liquid of interest within the material. The system also includes where the vacuum chamber is configured to expose the preheated vessel to a pressure of about 140 torr for a period of time to extract the liquid of interest from the material. The system also includes a liquid collection module, which may include: a collection pan; and a collection pot, where the collection pan is in fluid connection with the collection pan.

Implementations may include one or more of the following features. The system for liquid recovery where the collection pan may include a gasket. The collection pan is configured to be moved into position to make contact with the preheated vessel during extraction. The collection pot is chilled. The system for liquid recovery may include a heating station configured to expose a vessel to a temperature for a period of time to produce a preheated vessel. The system for liquid recovery may include one or more entry and/or exit rail systems for vessel loading, vessel unloading, or vessel transport. The system for liquid recovery may include a vessel cart for moving a vessel between components of the system.

One general aspect includes a system for liquid recovery. The system also includes a heating station configured to receive a vessel made of a material, the vessel having an amount of a liquid of interest within the material. The system also includes where the heating station is configured to expose the vessel to a temperature for a period of time to produce a preheated vessel. The system also includes a vacuum chamber that may include at least one sidewall and at least one door being configured to receive the preheated vessel. The system also includes where the vacuum chamber is configured to expose the preheated vessel to a pressure of about 140 torr for a period of time to extract the liquid of interest from the material. The system also includes a liquid collection module, which may include: a collection pan; and a collection pot, where the collection pan is in fluid connection with the collection pan.

Implementations may include one or more of the following features. The system for liquid recovery where the collection pan may include a gasket. The collection pan being configured to move into position to make contact with the preheated vessel during extraction. The collection pot being chilled.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows one implementation of a system for liquid recovery according to the principles of the present disclosure.

FIG. 2A shows one implementation of a chamber of a heating station according to the principles of the present disclosure.

FIG. 2B shows one implementation of a chamber of a heating station with a vessel inside the chamber according to the principles of the present disclosure.

FIG. 2C shows one implementation of a chamber of a heating station while heating with a vessel inside the chamber according to the principles of the present disclosure.

FIG. 3 shows one implementation of a system for liquid recovery according to the principles of the present disclosure.

FIG. 4A shows one implementation of a vacuum chamber with a vessel inside the chamber according to the principles of the present disclosure.

FIG. 4B shows one implementation of a vacuum chamber with a collection pan in a lowered position within the chamber according to the principles of the present disclosure.

FIG. 4C shows one implementation of a vacuum chamber with a collection pan in a raised position in contact with the vessel according to the principles of the present disclosure.

FIG. 5A is a perspective view of one implementation of a vacuum chamber having an extraction assembly including a vacuum pump according to the principles of the present disclosure.

FIG. 5B is a perspective view of one implementation of a collection pot according to the principles of the present disclosure.

FIG. 5C is a perspective view of one implementation of a vacuum chamber having an extraction assembly including a vacuum pump according to the principles of the present disclosure.

FIG. 6 is a flowchart of one implementation of a method of liquid recovery according to the principles of the present disclosure.

### DETAILED DESCRIPTION OF THE DISCLOSURE

The present disclosure is a method and system that uses a combination of heat and vacuum to extract a useable liquid product (e.g., liquid of interest) from a vessel (e.g., wooden barrel). In one implementation, a combination of preheating and vacuum is used to extract bourbon from an aging barrel, a wooden barrel used for aging the contents. In certain implementations, the aging barrel is made of American white oak that has been used to age its contents for 2-12 years. The recovered, or extracted, useable liquid product according to the principles of the present disclosure does not require any post-recovery concertation steps and may be blended into a variety of products or may be a usable liquid product that is premium in nature. In some implementations, the aging barrel is not damaged during the recovery process and may be re-used for other purposes or sold on the secondary market.

In one implementation, during the spirit maturation process the porous wood of a barrel absorbs a portion of the spirit (i.e., useable liquid product) thus decreasing the total recoverable liquid when the barrel is emptied. As a result, manufacturers have in attempt to minimize losses due to implemented varying recovery p absorption, evaporation, and other factors. Existing recovery processes are often water, time, and warehouse intensive, requiring significant amounts of labor, water, energy, and space to extract a small amount of useable (e.g., saleable) liquid product. For example, soaked or rinsed liquid has proof, but cannot be used as straight spirit, so it is instead used to ‘cut’ proof—or reduce the alcohol content of a bulk volume of spirit for bottling or blending. There is a finite volume of any spirit available to the market “coming of age” at any one time—for products with an extended manufacturing life cycle (e.g., 4-13+ years), which creates a massive incentive for manufactures to maximize their yield. Liquid not extracted from the vessel (e.g., wooden barrel) is lost to the world and eventually evaporates or is lost when an empty barrel is sold or reused for another product.

One implementation of the present disclosure is a system comprising a vacuum chamber with two doors for barrel transfers; a means for heating the used aging barrel such as radiant lamps, cartridge elements, band heaters, or the like; a vacuum pump capable of pumping and reaching a vacuum level equal to or less than the vapor pressure of ethanol at room temperature (44 Torr) (e.g., for spirits); a collection pot for the product recovered from the barrel; a valve on the foreline of the vacuum pump for modulating applied vacuum levels; a vacuum gauge for indicating vacuum level; one or more thermocouples for measuring barrel temperature; and, an alcohol meter for determining extract proof levels for useable liquid products that contain alcohol.

In one implementation of the system of the present disclosure, after being emptied, a barrel is conveyed to a preheat zone that interfaces with a rail system used to carry the barrel. Once heated, the barrel is loaded into a vacuum chamber. In one implementation an operator closes the vacuum chamber door(s) and starts the process via a control panel to begin the vacuum extraction cycle. The liquid of interest held within the material of the vessel is collected and in certain implementations can be seen running through a line to a collection point on the bottom of vacuum chamber. The useable liquid product yielded is collected in a collection pot, ready to be reintegrated in the standard manufacturing process or to be sold as a premium product. In some implementations, the detailed results of the run, including volume extracted, are displayed on a control panel.

In recent tests with a sample size of bourbon barrels, results found that approximately 600 ml-1200 ml of high-quality useable liquid product was recovered during a vacuum chamber recovery exercise on a preheated vessel. This is a more efficient process to extract excess saleable liquid than previous efforts that seamlessly integrates into existing manufacturing process and extracts liquid of equal or exceeding quality when compared to the bulk volume of liquid stored in the vessel. In some cases, a reduced environmental impact compared to other processes is achieved through minimizing water consumption, energy use, and storage requirements.

In one implementation, an aging bourbon barrel yielded extract in a volume of about 750 ml-1000 ml in five minutes or less. This testing was conducted using barrels dumped many weeks prior to testing. Initial data indicates that freshly dumped barrels could yield significantly higher amounts of spirits in the about 1000 ml-1500 ml range. The recovered product, or extract, had a superior product quality and taste as compared to existing water soaking methods and had little to no “post-recovery” blending or mixing or concentration requirements to produce a finished product. The average quality of the spirits extracted exceeded the quality of the bulk value in three key metrics; color, % ABV, and acidity, making it a useable liquid product. Results indicate that the bound spirit (that was held in the material of the vessel) had higher proof, color, and acids. In certain implementations, the preheating process aids in the recovery of more bound spirits via movement through the wood to the surface.

Energy consumption requirements of the system are modest as compared to previous recovery methods, and the footprint of the system can be accommodated on a processing line in a distilling facility, an aging operation, or similar at significant cost savings. In some cases, the method and system of the present disclosure is used to recover bourbon from aging barrels, recover wine from aging barrels, recover distilled spirits, such as rum and tequila, from aging barrels, recover soy sauce and olive oil from aging barrels, and the like.

The methods, systems, and apparatus of the present disclosure, may be automated by one of skill in the art. In one implementation, one or more activities that are manually performed by a user interacting with a computer or apparatus may be automated for performance by a robot, or the like. For each of the one or more identified activities, activity information associated with the activity may be generated and a process definition for use in causing a robot to automatically perform the process is generated.

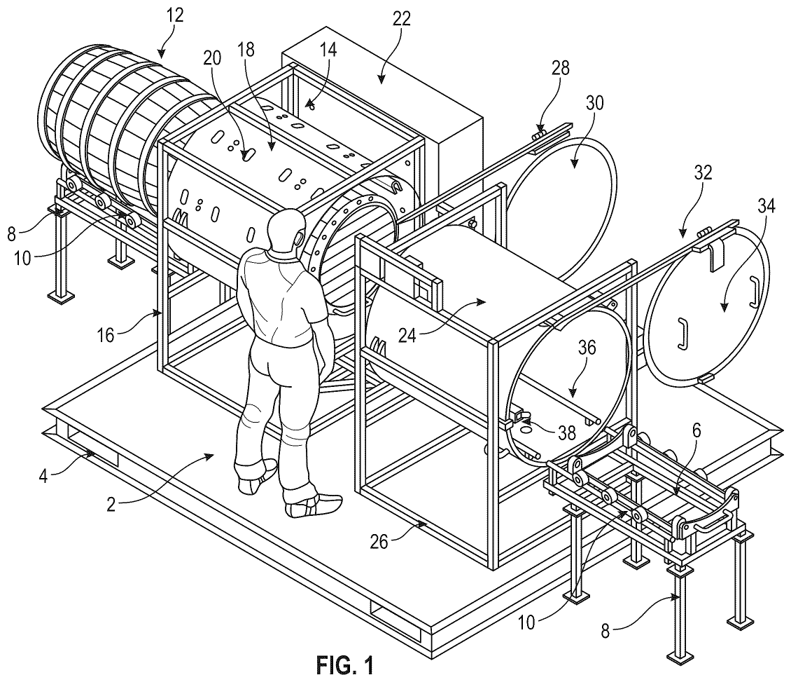

Referring to FIG. 1, one implementation of a system for liquid recovery is shown. More specifically, in this implementation all components are mounted on a skid 2 which is transportable via commercial trucking for ease in on-site placement. In some cases, fork truck access points 4 are also included for loading, unloading, and placement of the system. In certain implementations, one or more entry and/or exit rail systems 6 are provided for vessel loading, vessel unloading, or vessel transport. In certain implementations the one or more entry and/or exit rail systems comprise a frame portion 8 and one or more rails 10 used to support and move a vessel 12 into and/or out of the various components of the system. In some cases, the frame portion 8 may be on casters, or the like, to facilitate moving the vessel into position while on the one or more entry and/or exit rail systems. In certain implementations, the one or more entry and/or exit rail systems 6 are installed off the skid 2. In some cases, the one or more entry and/or exit rail systems may be mounted on the skid for transport.

In certain implementations, a heating station 14, or preheat zone is present. In one implementation, the heating station 14 has a frame structure 16 to support a chamber 18 and a plurality of heating sources such as radiant lamps 20, blanket heaters, or the like, that are distributed around the vessel when inside the chamber 18 of the heating station for uniform heating. In certain implementations, a chamber 18 supporting the plurality of heat lamps, or the like, is cylindrical to accommodate a barrel. In certain implementations, a rail system (not shown in this figure) is incorporated within the chamber 18 of the heating station to aid in positioning a vessel. In certain implementations, 16 kW of IR lamps are mounted to the chamber 18 of the heating station.

Still referring to FIG. 1, to provide for vessel transport into and/or out of the preheat zone, sliding door(s) with heat lamps (not shown) can be moved so the vessel can roll into a heating position. In some implementations, a mechanical stop is provided to position the vessel within the preheat zone. In some cases, the preheat zone is fully enclosed. In certain cases, thermocouples 22 are also provided for feedback control of the plurality of heat lamps, or the like, as well as temperature indication for the preheat zone.

In certain implementations, a vacuum chamber 24 is supported on a frame 26. In certain implementations, the frame 26 supports a first door sliding rail 28 for a first door 30. In certain implementations, the frame 26 supports a second door sliding rail 32 for a second door 34. In some cases, the vacuum chamber 24 is manufactured from stainless steel. In some cases, the vacuum chamber 24 is about 32 inches in diameter and about 40 inches long. In certain implementations the vacuum chamber has ports for vacuum pumping and instrumentation. In one implementation, the second door 34 is bolted to the vacuum chamber but can be removed for service. In some cases, both first and second doors incorporate a gasket to provide for a vacuum seal. In certain implementations, the first door actuation is manual.

In certain implementations, a rail system 36 is incorporated within the vacuum chamber to aid in positioning a vessel therein. In one implementation, a port 38 is located in a lower region of the vacuum chamber and is used for pumping and/or fluid extraction.

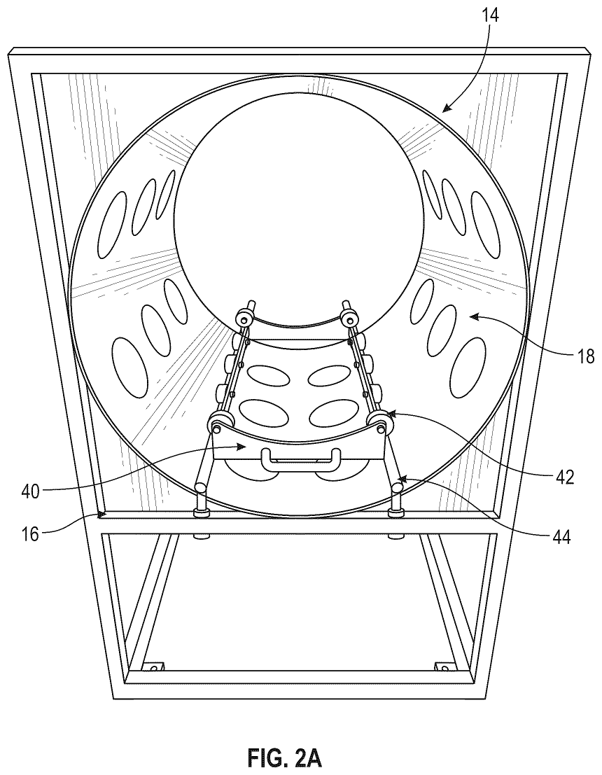

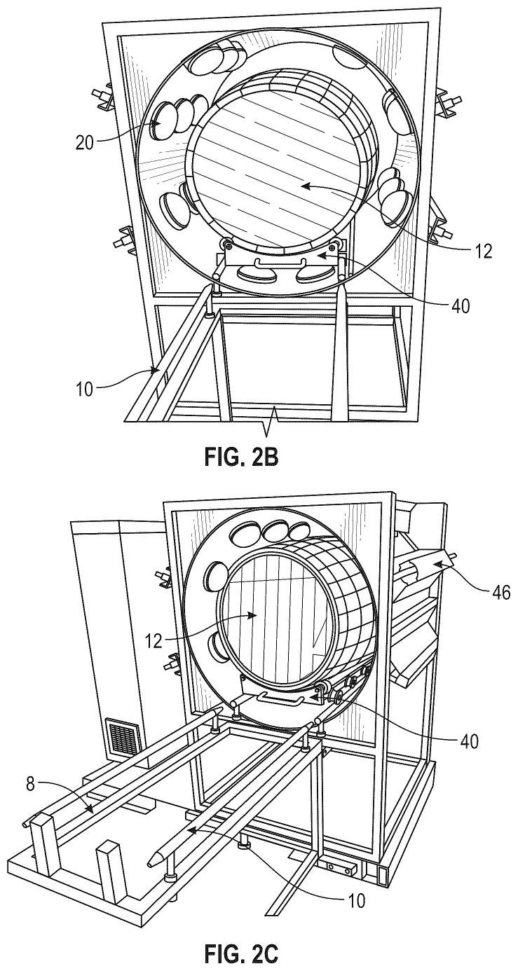

Referring to FIG. 2A, one implementation of a chamber of a heating station according to the principles of the present disclosure is shown. More specifically, the heating station 14 has a frame structure 16 to support a chamber 18 and a plurality of heat lamps, or the like, which are distributed around the vessel when inside the heating station for uniform heating. In certain implementations, the chamber 18 for supporting a plurality of heat lamps, or the like, is cylindrical to accommodate a barrel. In certain implementations, a rail system 44 is incorporated within the chamber 18 of the heating station to aid in positioning a vessel.

Still referring to FIG. 2A, in some implementations a vessel cart 40 slides along rail(s) 26 and is configured to move the vessel within the system. In one implementation, the vessel cart 40 moves the vessel from the preheat zone exit, and slides it into the vacuum chamber. As the vessel rolls out of the preheat zone it rolls on the vessel cart on the rails. The vessel cart is then pushed into the vacuum chamber. In some cases, rollers 42 are provided on the vessel cart 40 so that the vessel may be rotated on the vessel cart for alignment of an opening in the vessel with the extraction assembly. After extraction and venting of the vacuum chamber, the vessel cart may be pulled out of the vacuum chamber and aligned to the entry and/or exit rail system so the vessel can be rolled onto the exit rails.

Referring to FIG. 2B, one implementation of a chamber of a heating station with a vessel inside the chamber according to the principles of the present disclosure is shown. More specifically, in certain implementations, a plurality of heat lamps 20 is 16 kW of infrared lamps mounted to the chamber of the heating station.

Referring to FIG. 2C, one implementation of a chamber of a heating station while heating with a vessel 12 inside the chamber according to the principles of the present disclosure is shown. More specifically, the entry and/or exit rail system can be seen. The one or more entry and/or exit rail systems comprise a frame portion 8 and one or more rails 10 used to support and move a vessel 12 into and/or out of the various components of the system. In certain implementations, the plurality of heat lamps are covered, at least partially, by a heat shield 46, or the like.

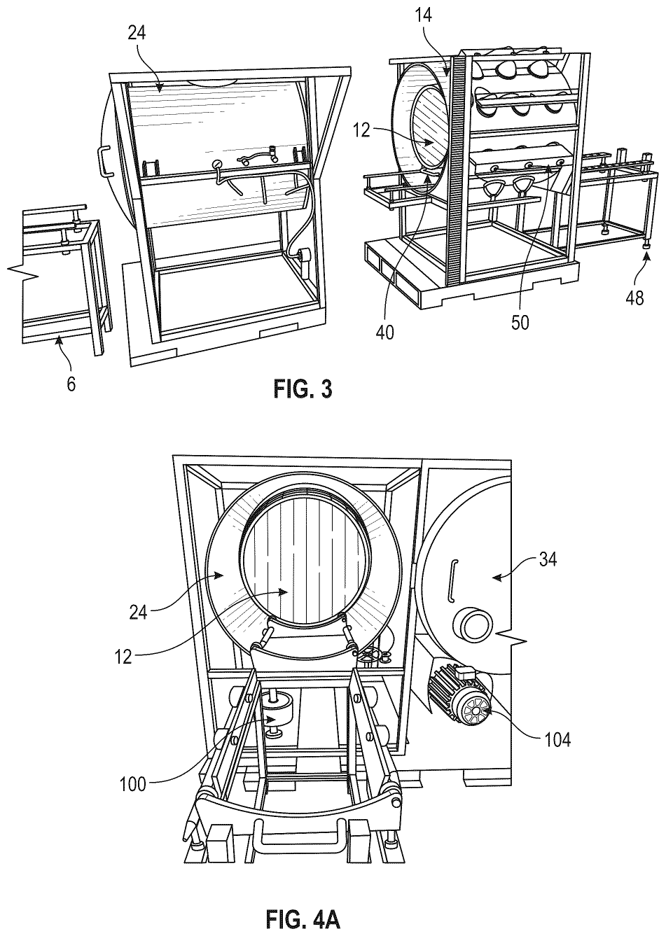

Referring to FIG. 3, one implementation of a system for liquid recovery according to the principles of the present disclosure is shown. More specifically, a pair of entry and/or exit rail systems 6 are shown on either end of the system. In certain implementations, the entry and/or exit rail systems 6 are on casters 48. In this figure, a vacuum chamber 24 is shown with it's doors closed. A heating station 14 is shown having a vessel 12 within, the vessel being on a vessel cart 40. In certain implementations, the plurality of heating lamps are wired such that one or more lamps are wired together in series 50, which are distributed around the chamber to surround the vessel and provide uniform heating.

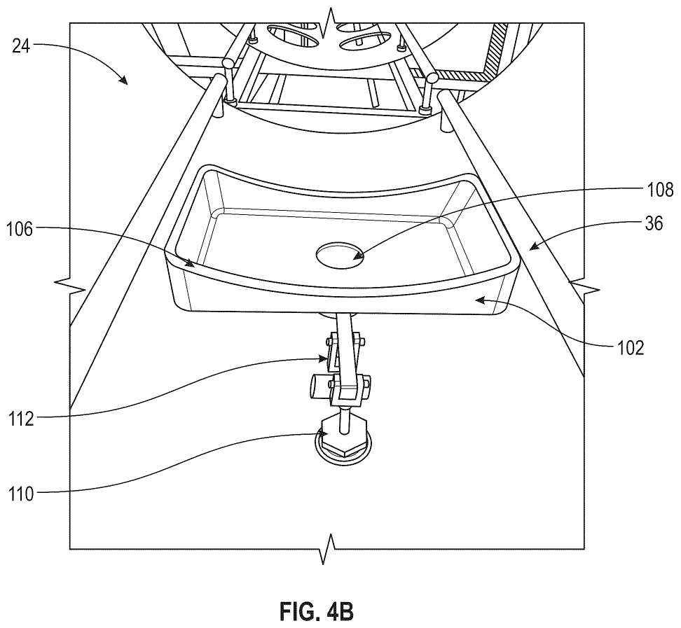

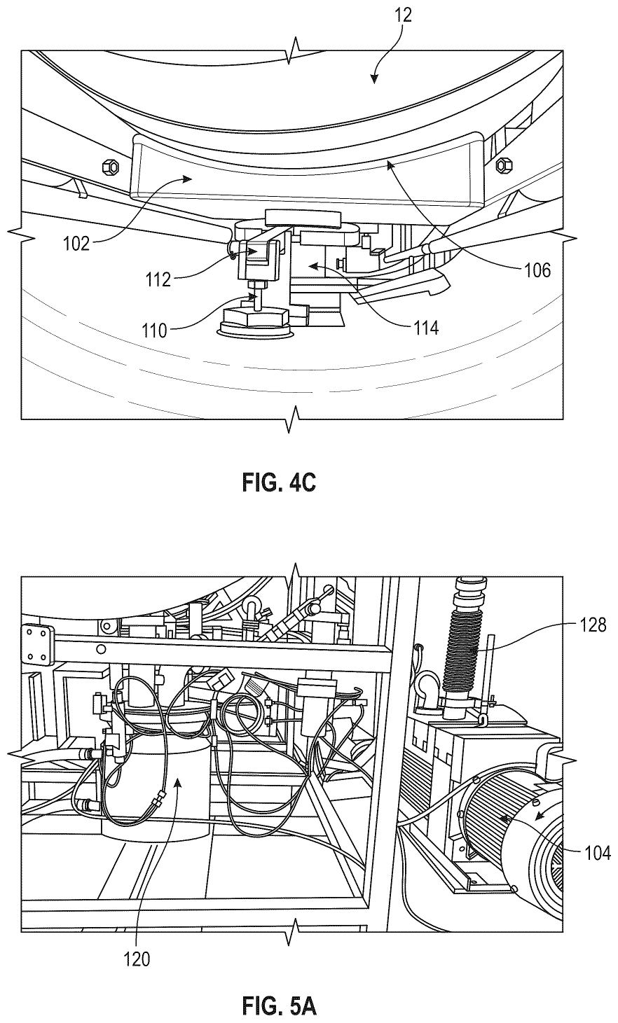

Referring to FIG. 4A, one implementation of a vacuum chamber with a vessel inside the chamber according to the principles of the present disclosure is shown. More specifically, an extraction assembly 100 provides for vacuum pumping of the vessel and chamber, via a vacuum pump 104 as well as capturing extracted liquid in a collection pot. In some cases, with the vessel 12 in position within the vacuum chamber 24 a bung hole (not shown), or the like, faces down and is aligned with the extraction assembly 100. In certain implementations, a portion of the extraction assembly is lifted into position to make contact with the vessel 12.

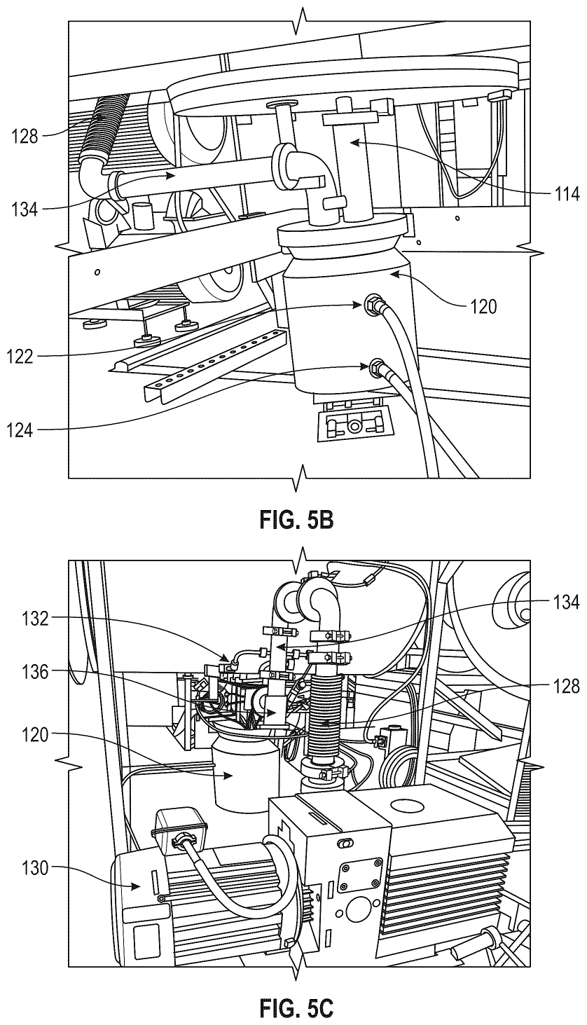

Referring to FIG. 4B, one implementation of a vacuum chamber 24 with a collection pan 102 in a lowered position within the chamber, to provide for unobstructed loading and unloading of vessels along rails 36 according to the principles of the present disclosure is shown. More specifically, a collection pan 102, or the like, is provided for guiding recovered liquid into a container (see e.g., FIG. 5A) or collection pot. In one implementation, the collection pan 102, or the like, is shaped to receive a vessel and has a gasket 106 to seal against the vessel during extraction. An outlet 108 formed in the base of the collection pan 102 is in fluid communication with piping in the extraction assembly. In one implementation, the collection pan 102 is raised or lowered using a piston 110 and a lever 112, or the like.

Referring to FIG. 4C, one implementation of a vacuum chamber with a collection pan in a raised position to contact with the vessel according to the principles of the present disclosure is shown. More specifically, a collection pan 102 in the raised position interfaces with the vessel 12 via a gasket 106, or the like, to provide a seal to improve evacuation results. In one implementation, the collection pan 102 is raised or lowered using a piston 110 and a lever 112, or the like. The collection pan 102, is in fluid communication with piping 114 of the extraction assembly.

Referring to FIG. 5A, a perspective view of one implementation of a vacuum chamber having an extraction assembly including a vacuum pump according to the principles of the present disclosure is shown. More specifically, a vacuum pump 104 and a collection pot 120 are shown. In one implementation, the collection pot 120 is water cooled to provide for any volatile compounds (e.g., ethanol that is vaporized during pumping) to condense before entering the vacuum pump 104 and is lost. In one implementation, there is a pumping manifold 128 that allows for staged pumping (e.g., slow pumping) to mitigate the vaporization of ethanol. In certain implementations, a by-pass or slow pumping manifold 132 is used.

Referring to FIG. 5B, a perspective view of one implementation of a collection pot according to the principles of the present disclosure is shown. More specifically, in one implementation, the collection pot 120 is double-walled. The outside wall is separated from the inner wall to allow for a water passage for cooling. The pot itself provides for the connection between the vacuum pump and the chamber (e.g., vacuum foreline 134/manifold 128) via piping 114. In some cases, extracted liquid resides within pipes and is held there by a shutoff valve. Once the chamber is vented, the shutoff valve opens and the fluid drains into a collection pot. In some implementations, once the liquid has been drained into the collection pot 120, a pump can pump the liquid out of the collection pot and into a line having a flow meter to provide feedback on the amount of fluid recovered from the vessel. In some cases, a dump line drains into a collection trough of the facility, or the like. In certain implementations, the collection pot is chilled (122, 124). By chilling the collection pot, reduced flammable fumes are present and may improve the quality of the collected liquid, by reducing changes in form (e.g., flavor, color, smell).

Referring to FIG. 5C a perspective view of one implementation of a vacuum chamber having an extraction assembly including a vacuum pump according to the principles of the present disclosure is shown. More specifically, one implementation of the vacuum system comprises a mechanical pump, foreline piping, roughing valve, pressure control valve, and manifold. The mechanical pump 130 is configured to evacuate the vacuum chamber via a foreline 134. In some cases, a roughing valve 136 is provided to start and stop the evacuation process. In certain implementations, a vacuum controller is installed to control the pressure of the chamber, e.g., to a minimum of about 100 Torr during the vessel extraction phase. In one implementation, the vacuum controller closes the roughing valve 136 at a certain vacuum level. The output is adjustable to allow for different setpoints (e.g., vacuum levels). In some cases, once the extraction phase is complete, the roughing valve 136 is closed and a vent is opened to vent the vacuum chamber. In certain implementations, venting is done to the atmosphere (vent not shown in the figure). In certain implementations, a by-pass or slow pumping manifold 132 is used.

Still referring to FIG. 5C, a pipe connects the pump to the chamber. This pipe is referred to as a vacuum foreline or foreline 134. In fluid communication with the foreline 134 is a water-cooled trap, also known as a collection pot 120. This is where the liquid (e.g., bourbon) collects when vacuum is applied to the vacuum chamber and vessel (e.g., wooden barrel). In certain implementations, the collection pot 120 is water cooled so any vapor will condense before it gets to the vacuum pump 130. The vacuum is regulated to—100-140 Torr (atmosphere is 760 Torr). In certain implementations, the pressure must not be reduced near or below the vapor pressure of ethanol to reduce the possibility of an explosion. In certain implementations, there is a burst disc (aka relief valve) on the vacuum chamber as a safety precaution.

In one implementation, a control system for the vessel liquid recovery system is manual. In some cases, a control panel is located on the entry to the system for operator convenience. In certain cases, emergency stop buttons are included; one located on the front (entry) of the system and one on the rear (exit). In some cases, heaters for the preheat zone are turned on/off manually. In some implementations, the heater power may be controlled via a temperature controller that can be set manually or automatically. In some cases, the pumping and venting of the vacuum chamber can be turned on/off manually. In some implementations, the vacuum level can be controlled via a vacuum controller. In certain implementations, engagement of the extraction assembly is manual. Vessel transport through the system may also be manual. In some cases, an operator will lift the vessel on to and off of the rail system. In certain implementations, when the collection pot is to be transferred to a drain trough, or the like, an operator can manually activate a liquid dumping system.

In certain implementations, power will be distributed from a single service drop box to all devices located on the system skid. A disconnect may be provided in the box to remove all power from one or more of the components. In one implementation, power to the single service drop box is a 208V/3 ph extension cord, or the like.

In one implementation of a method of fluid recovery, an aging barrel is placed into a vacuum chamber, though not necessarily limited to a vacuum chamber of the configuration described herein, and a means for external heating of the barrel is provided (e.g., heater blankets, radiant lamps, resistive coils, etc.). Next, a vacuum chamber/vessel door is closed, and a vacuum is produced in the chamber. In one implementation, the vacuum is no lower than the vapor pressure of ethanol at room temperature (44 Torr). In one implementation, external heating of no more than 200° F. is then applied. In one implementation the wooden vessel reaches about 120-140° F.

Heating is applied to the aging barrel for a period of time. In one implementation the time is about 10 minutes or less. The liquid of interest present in the material of the vessel is extracted into a collection pot. The extracted product may contain some char from the lining of the barrel, or the like. In some implementations, passing the extracted liquid through a 0.5-micron filter assembly, or the like, produces a consistently sedimentation-free product that is not altered in color or proof.

TABLE 2
Exemplary parameters/values for some implementations
of a method of the present disclosure.

| Parameter | Value |
|---|---|
| Preheat time & temperature with | 2 hr at about 130° F. |
| vessel in a heated room | |
| Preheat time & temperature with | ~10 min at about 250° F. |
| vessel in a heating blanket | |
| Preheat time & temperature with | <10 min at about 200° F. |
| vessel in a heating station | |
| Preheated Final vessel surface | 115° F. ± 10 at head, 183° F. ± 15 |
| temperature | at bilge |
| Vacuum chamber cycle time | About 5 minutes |
| Vacuum achieved in 5 minutes | ~195 torr at chamber, ~180 torr at |
| | foreline |
| Barrel (vessel) entry and exit timing | ~5 minutes, would be less with |
| | automation |

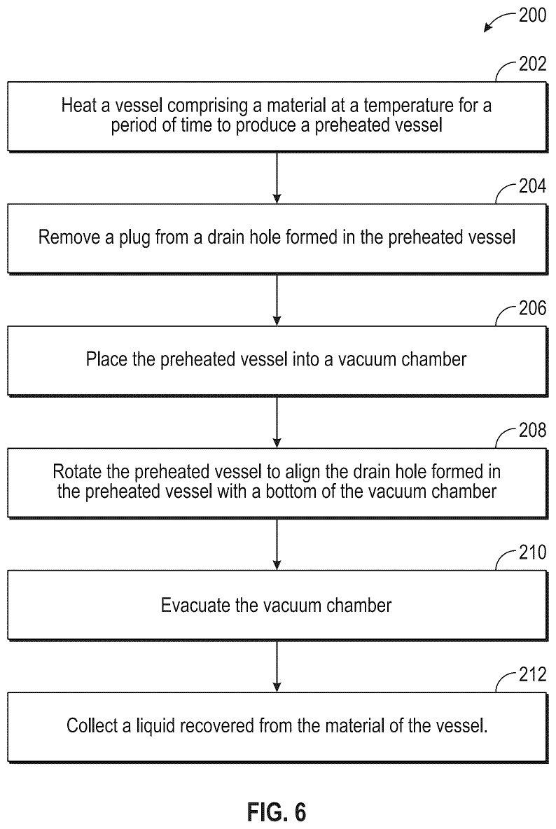

Referring to FIG. 6, a flowchart of one implementation of a method of fluid recovery 200 is shown. More specifically, a vessel comprised of a material having a liquid of interest therein is heated to about 140° F. 202. Once the vessel has been heated, a drain plug is removed from a drain hole formed in the vessel 204. The vessel is placed into a vacuum chamber 206. The vessel is rotated to align the drain hole with the bottom of the vacuum chamber 208. A collection pan is moved into fluid connection with the drain hole. The vacuum chamber is evacuated 210. After a set time (e.g., about 4-10 minutes) a foreline valve is closed to isolate the vacuum chamber from the vacuum pump. In certain implementations, the vacuum chamber is vented to atmosphere. Liquid recovered from the material of the vessel is collected 212. Once venting is complete, the vacuum chamber can be opened, and the vessel removed. In certain implementations, this process is repeated for a series of vessels.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described implementations can be implemented in any of numerous ways. For example, implementations of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various implementations of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of implementations as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various implementations.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the invention. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +1-2% of the stated value (or range of values), +1-5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “having,” “carrying,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various implementations of the disclosure are examples and the disclosure is not limited to the exact details shown or described.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. A method for liquid recovery, comprising:
heating a vessel comprising a material comprising a liquid within the material at a temperature for a period of time to produce a preheated vessel;
placing the preheated vessel into a vacuum chamber;
evacuating the vacuum chamber; and
collecting at least a portion of the liquid from within the material of the vessel.

2. The method for liquid recovery according to claim 1, wherein heating the vessel is to a temperature of about 140° F.

3. The method for liquid recovery according to claim 1, wherein heating the vessel at temperature of 200° F. or less for a period of time of less than 10 minutes.

4. The method for liquid recovery according to claim 1, further comprising:
removing a plug from a drain hole formed in the preheated vessel;
rotating the preheated vessel to align the drain hole formed in the preheated vessel with a bottom of the vacuum chamber; and
moving a collection pan into fluid connection with the drain hole formed in the vessel.

5. The method for liquid recovery according to claim 1, wherein evacuating the vacuum chamber is to a pressure of about 100 to about 140 Torr for about 4 to 10 minutes.

6. The method for liquid recovery according to claim 1, further comprising closing a foreline to isolate the vacuum chamber from a vacuum pump.

7. The method for liquid recovery according to claim 1, further comprising venting the vacuum chamber to atmosphere.

8. The method for liquid recovery according to claim 1, further comprising collecting the liquid of interest in a collection pot that is chilled.

9. A system for liquid recovery, comprising:
a vacuum chamber comprising at least one sidewall and at least one door being configured to receive a preheated vessel made of a material, the preheated vessel having an amount of a liquid of interest within the material;
wherein the vacuum chamber is configured to expose the preheated vessel to a pressure of about 100 to about 140 Torr for a period of time to extract the liquid of interest from the material; and
a liquid collection module, comprising:
a collection pan; and
a collection pot, wherein the collection pan is in fluid connection with the collection pan.

10. The system for liquid recovery according to claim 9, wherein the collection pan comprises a gasket.

11. The system for liquid recovery according to claim 9, wherein the collection pan is configured to moved into position to make contact with the preheated vessel during extraction.

12. The system for liquid recovery according to claim 9, wherein the collection pot is chilled.

13. The system for liquid recovery according to claim 9, further comprising a heating station configured to expose a vessel to a temperature for a period of time to produce a preheated vessel.

14. The system for liquid recovery according to claim 9, further comprising one or more entry and/or exit rail systems for vessel loading, vessel unloading, or vessel transport.

15. The system for liquid recovery according to claim 9, further comprising a vessel cart for moving a vessel between components of the system.

16. A system for liquid recovery, comprising:
a heating station configured to receive a vessel made of a material, the vessel having an amount of a liquid of interest within the material;
wherein the heating station is configured to expose the vessel to a temperature for a period of time to produce a preheated vessel;
a vacuum chamber comprising at least one sidewall and at least one door being configured to receive the preheated vessel;
wherein the vacuum chamber is configured to expose the preheated vessel to a pressure of about 100 to about 140 Torr for a period of time to extract the liquid of interest from the material; and
a liquid collection module, comprising:
a collection pan; and
a collection pot, wherein the collection pan is in fluid connection with the collection pan.

17. The system for liquid recovery according to claim 16, wherein the collection pan comprises a gasket.

18. The system for liquid recovery according to claim 16, wherein the collection pan is configured to move into position to make contact with the preheated vessel during extraction.

19. The system for liquid recovery according to claim 16, wherein the collection pot is chilled.

20. The system for liquid recovery according to claim 16, further comprising one or more entry and/or exit rail systems for vessel loading, vessel unloading, or vessel transport.
